(19) United States
(12) Patent Application Publication
(10) Pub. No.: US 2021/0107765 A1
(43) Pub. Date: Apr. 15, 2021

(54) Modular Rotary Feed-through with Energy Guiding Chains

(71) Applicant: igus GmbH, Köln (DE)

(72) Inventor: Georg Theiß, Köln (DE)

(73) Assignee: igus GmbH, Köln (DE)

(21) Appl. No.: 17/044,777

(22) PCT Filed: Apr. 3, 2019
(86) PCT No.: PCT/EP2019/058437

§ 371 Date: Oct. 1, 2020

(30) Foreign Application Priority Data
Apr. 4, 2018 (DE) 20 2018 101 827.2

(51) Int. Cl. B65H 75/44; F16G 13/16; H02G 11/02

(52) U.S. Cl. CPC B65H 75/4449; H02G 11/02; F16G 13/16

(57) ABSTRACT

The invention relates to a modular rotary feed-through (1, 2) for circular movements across a limited rotational angle of one or multiple lines such as cables, hoses, or the like between two connecting points (A, B) which are rotatable relative to one another about a rotational axis. Therein, the line(s) is/are guided in an uninterrupted manner, i.e., without slip rings, rotary couplings or the like. The rotary feed-through (1, 2) has a first winding core (11a, 11) which is rotatable about the rotational axis (R) and which has a first energy guide chain (12a, 12) which winds and unwinds in a spiraling manner, correspondingly to a planar spiral. According to the invention, at least one second winding core (11b, 11) is provided axially adjacent, coaxial and rotatable about the rotational axis (R) relative to the first winding core (11a, 11), which second winding core (11b, 11) is equipped with a second energy guide chain (12b, 12). During its rotation, the second winding core (11b, 11) winds and unwinds the second energy guide chain (12b, 12) in a spiraling manner, correspondingly to a planar spiral. Furthermore, according to the invention, a connection (17, 27) for the uninterrupted feed-through of the at least one line is provided between the first energy guide chain (12a, 12) and the second energy guide chain (12b, 12).

The invention generally relates to a rotary feed-through for at least one electrical, pneumatic and/or hydraulic line, such as cables, hoses or the like, which is to be guided between connecting points rotatable relative to each other about a rotational axis.

Endlessly rotatable rotary couplings for media or hose lines are known from the hydraulics and pneumatics sectors. For electrical power or signals, elements such as slip rings or slip contacts are sufficiently known for endless rotary transmission. Both solutions require an interruption of the line(s) in order to connect the interfaces on both sides to the coupling or the slip ring. In addition, rotary couplings for multiple, different operational media are technically complex.

The invention, on the other hand, relates specifically to a rotary feed-through for circular movements of at least one flexible line, in which the at least one line is uninterrupted but said movement is limited to a certain rotational angle. The invention thus relates in particular to a rotary feed-through which allows a possibly limited rotational angle without interruption of the line(s).

A system of this type is already known from the German patent DE 10 2012 110 967 B4. This system allows for winding and unwinding multiple lines, even for different media (electricity, data, gas, liquid, etc.)—without an interrupting rotary coupling—by means of a single drum. Therein, the drum has a winding core that is rotatable about the rotational axis with a conventional energy guide chain for guiding the lines. The inner end of the energy guide chain is fixed at the winding core. By turning the winding core, the energy guide chain is wound and unwound in the manner of a drum. Systems designed on the basis of the principle of DE 10 2012 110 967 B4 are marketed by the applicant (igus GmbH, D 51147 Cologne) under the trade name “e-spool”, and have proven themselves. In these systems, a special rotary guide is used to avoid the interruption of the lines typical for conventional solutions, e.g., according to patent EP 2 526 599 B1, with a ribbon-like line guide device, which guides the lines on a helical path with two helical layers wound in opposite directions. This special solution is available from the applicant under the trade name “twister-band”. This particular process—with helices or windings rotating in opposite directions and the turnover of the line(s) arranged between the two helical strands and moving axially between the same—makes it possible to use continuous lines, even across very large rotational angles, e.g., of several thousand degrees. Rotary feed-throughs according to DE 10 2012 110 967 B4 and EP 2 526 599 B1 are well-suited for small to medium cable diameters and chain loads or filling weights. However, a certain installation length is necessary in the axial direction, which increases with the desired rotational angle. The system is custom-made according to the desired rotational angle.

In contrast, the applicant has also developed a modular circular chain system, which it offers under the trade name “Multi Rotation Module (MRM)” (igus GmbH, D 51147 Cologne). The basic principle of such non-interrupting rotary feed-throughs is disclosed in the patent EP 2 732 519 B1 or U.S. Pat. No. 9,287,694 B2. Here, individual modules with circular guide channels are used, in which the energy guide chains move back and forth along a circular travel path while positioned on their sides.

For this purpose, RBR energy guide chains are required to allow for a close contact of the inner strand with the radial inner part of the guide channel. “RBR” stands for “reverse bending radius,” i.e., the energy guide chain can be angled in both pivot directions. The reverse radius (beyond the fully extended position) can be significantly larger than the normal radius or actual main radius in the deflection curve. A single MRM module according to the principle of EP 2 732 519 B1 or U.S. Pat. No. 9,287,694 B2 can achieve rotational angles of ≥540°. Thanks to the modular design, however, the rotational angles can be expanded almost indefinitely. The MRM system is ideal for high filling weights or chain loads. It is used in rotatable heavy machinery or systems, such as rotary cranes, bucket wheel excavators, mining stackers, wind turbines, etc. It typically has a diameter of at least 1,000 mm (always >>4-times normal chain radius) and is associated with a certain manufacturing and assembly complexity, due to the circular, special guide channels, among other factors.

Based on the above state of the art, there is a need for an uninterrupted rotary feed-through in a modularly expandable design, which is axially compact and/or is well suited for lower filling weights and/or line diameters.

One problem underlying the present invention therefore is to propose an alternative system for uninterrupted circular movements of at least one line that has a compact design, in particular with small axial dimensions, and which can be used in a modular manner. The solution should also be inexpensive to manufacture and/or easy to mount.

This problem is solved by a system or a rotary feed-through according to Claim 1 or independently thereof according to Claim 16.

A generic rotary feed-through for circular movements across a limited rotational angle is intended to guide at least one flexible line, such as a cable, hose, etc., between two connecting points rotatable relative to each other about a rotational axis without an interruption in said line. It comprises a first winding core rotatable about the rotational axis with a first energy guide chain for guiding the at least one line. The radial inner end of the energy guide chain therein is fixed at the winding core, in particular is pivotable, e.g., by a type of fastening at said end. By rotating the first winding core, the first energy guide chain is wound or unwound helically, corresponding to a planar helix, onto or from said winding core, depending on the rotational direction.

According to the invention, at least one second winding core is provided initially, which is axially adjacent to the first winding core, and which is arranged coaxially and rotatably, in particular rotatable relative to the first winding core, i.e., at least rotatable across a certain angle independently from it. In addition, the second winding core also has its own energy guide chain associated with it, referred to as the second energy guide chain, the inner end of which is fixed at the winding core. The second winding core, too, winds or unwinds the second energy guide chain helically, corresponding to a planar helix, depending on the rotational direction, equivalent in principle to the manner of the first winding core. This is either done in the same direction as in the first winding core, or preferably in the opposite rotational direction of the helical windings from the first to the second winding core. Therein, each winding core can be a single- or multi-component winding body.

Furthermore, a suitable connection is provided between the first energy guide chain and the second energy guide chain for feeding through the at least one line, which connection can, for example, also transfer the torque between the winding cores; however, the concrete design of said connection is not important in principle apart from its being able to guide a line. The connection may be provided between the two outer ends, or between an outer and an inner end of the energy guide chains.

The two energy guide chains in particular have a path similar to a spiral arm, which is coiled or wound more or less tightly around the respective winding core depending on the relative rotational position. Unlike in DE 10 2012 110 967 B4, the energy guide chain herein is not reeled on or off as if on a drum. Rather, the winding distance, similar to a helical spring, increases or decreases when winding or unwinding, but without a uniformity of the relative position and distances between helical windings or spiral arms (seen in the radial direction or in the axial cross-section) being of any importance.

In contrast to the solutions mentioned above, this solution neither requires the screw-shaped, double-helical path with the moving turning point, which requires much space in the axial direction, nor does it require special RBR energy guide chains or special guide channels.

The helical arrangement of the energy guide chains in multiple planes allows for very large rotational angles, e.g., well over 360° per winding core. The overall size initially scales radially with the selected or windable chain length. The maximum possible rotational angle per rotation plane or winding core is primarily dependent on the installable, windable chain length, which in turn is determined by the ratio of outer diameter to inner diameter of the available installation space. If the radial installation space is used completely, the rotational angle can be increased in small steps with each additional stage in the axial direction, e.g., a third, fourth, etc. winding core, if necessary. Thus, the proposed solution can be of a relatively compact axial design even at large rotational angles, e.g., >>1,000 degrees. In addition, smaller radii are possible than, for example, in the aforementioned MRM systems, depending on the desired rotational angle per module. A minimum diameter is specified in that the windings in their wound state lie on top of each other without space between the windings, and in that the number of windings depends on the desired chain length or the rotational angle per module. The required radial dimensions can accordingly be relatively compact, especially with small line diameters.

Each of the energy guide chains is arranged with its own plane of movement at a right angle to the rotational axis for the respective planar helical movement.

Depending on whether axially successive energy guide chains are wound onto the associated winding core in the same direction or not, the connection, which is provided for feeding through the at least one line between the successive energy guide chains, may either connect the radial outer end of the first energy guide chain with the radial inner end of the second energy guide chain, or may be provided between both radial outer ends of the first and second energy guide chains. The latter is a preferred design in combination with the opposite winding direction of both energy guide chains in one module.

The proposed design is preferably executed in a modular manner, wherein a module comprises at least one winding core, the energy guide chain fixed to it at its end and a connecting body for transferring rotational movement, and wherein multiple modules are used, which are of identical design and match each other. The connecting body may, for example, be attached in a rotationally fixed manner to the second winding core following it in the direction of the line, or include said second winding core as a component. A module can also comprise two winding cores, each with its own energy guide chain.

To simplify the modularity, the rotatable support of individual winding cores relative to each other and/or the line guidance, a preferred exemplary embodiment provides that at least one winding core has a central, axially continuous hollow cylindrical receptacle coaxially to the rotational axis. This receptacle preferably has a section with a circular cross-section and can thus interact with a rotating support counterpart for providing rotatable support, for example, on the axially adjacent winding core or connecting body. The receptacle can also be used for the line feed-through between individual modules. Preferably, both or all winding cores are identically designed, i.e., each has a central, hollow, cylindrical receptacle.

In particular in the latter design, a winding core arranged on the axial end can itself form one of the connecting points or be firmly connected to the same.

Preferably, all winding cores and all energy guide chains are identical in design. This increases the number of identical parts in the system, i.e., reduces manufacturing and inventory costs. Particularly preferably, the two energy guide chains have exactly one or only one predefined pivoting or curving direction, or both can be angled only in a predefined pivoting direction. These are therefore preferably not RBR chains.

In a particularly preferred embodiment, however, the winding direction is opposite in a module, or in two axially successive energy guide chains, i.e., the first energy guide chain and second energy guide chain extend helically around the associated winding core in opposite rotational directions, which is clearly recognizable at least when they are wound. Therein, it is preferable if the two radially outer ends, that is, those farthest away from the winding core, of the first and second energy guide chain are connected by means of a special connecting link for feeding through the at least one line. In this arrangement, a basic module consists of two winding cores and two energy guide chains, i.e., it is preferably to provide an even number of winding cores and energy guide chains.

The connecting link can preferably have respective joint halves on both sides, which are identical to a joint half of a chain link, wherein the joint halves are offset axially to each other by at least the chain width. In particular, identical energy guide chains in this manner can be solidly connected without further measures.

In particular, but not exclusively, in the preferred embodiment with windings in opposite directions, the rotational movement or torque can be transferred from the first winding core to the second winding core or vice versa by means of both energy guide chains. In other words, the force/torque transfer can be carried out within the module via both energy guide chains and, if necessary, the connecting link. Thus, no special gearing solution, rotary mechanism, guide channel coupling or the like is required. This simplified design is achieved in any case if the force and/or torque transfer is executed by means of the line guide device associated with the first winding core and/or by means of the line guide device associated with the second winding core. The energy guide chain is inherently suitable for this purpose due to its tensile/shear strength.

Alternatively, in particular in the case of windings not wound in opposite directions, the outer end of the first energy guide chain may be connected to the second winding core via a radially extended connecting body, for example, a type of turntable or a connecting arm. This also can be used to transfer rotational movement from the first winding core to the second winding core or vice versa by force transfer via the first energy guide chain and additionally via the connecting body. The connecting body can act as a lever arm and can be formed, for example, by a type of support disc. The advantage of a system with windings that are always wound in the same direction is that each group of winding core and energy guide chain forms a basic module, which means that a rotary feed-through can be easily created even with an odd number of winding stages. Energy guide chains also are inherently suitable for driving via a connecting body because of their typical stability in the longitudinal direction.

The force/torque transfer from one winding core to the next is therefore executed by means of an energy guide chain and, if necessary, other components.

It should also be noted that the proposed system is easily expandable in a modular manner, i.e., in particular a third winding core that is rotatable about the rotational axis with a third energy guide chain arranged in a correspondingly helical manner and preferably a fourth winding core rotatable about the rotational axis with a fourth energy guide chain arranged in a correspondingly helical manner may be provided. Preferably, all winding cores are coaxial and rotatable relative to each other and independently of each other, in particular at least across a certain rotational angle. All energy guide chains preferably take the aforementioned helical path similar to a spiral arm with increasingly narrow or expanding course, depending on the rotational position.

In the case of the preferred use of energy guide chains as line guide devices, all energy guide chains preferably are identical in design, in particular constructed from individual chain links pivotable relative to each other. This facilitates the manufacturing, mounting and, especially in the case of helical paths alternating in opposite directions, the connection of two chains due to joint halves of identical design.

It is possible to use energy guide chains preloaded into the fully extended position in the pivot direction, which corresponds to the rotational direction of the helix around the winding core. This allows also for transferring higher torques, if necessary, if the energy guide chains form a fully extended longitudinal section, especially in their fully unwound position. In particular in the case of link chains for guiding lines, it is advantageous if the first and second winding core, in particular all winding bodies, each comprise a connection area, which is designed for connecting the chain link at the inner end of the energy guide chain and for this purpose has a joint half of an identical design as a chain link of the energy guide chain. This makes it easier to use conventional energy guide chains.

The winding cores, in turn, preferably have an extensive contact surface on their outer side, as seen in the radial direction, for their respective associated energy guide chains, which contact surface is designed, starting from the connection area, to match the wound spiral shape—as seen in its radial cross-section—and in particular follows an archimedic spiral. This allows for a stable contact of the winding at the winding core in the wound position, which means uneven stress due to the constricting effect of the windings tightening on the winding core in this position can be avoided. The contact area in particular can have a steadily increasing radius. The initial radius should be larger than the normal deflection radius of the associated energy guide chain.

With regard to the dynamic process, the design is therefore preferably chosen such that each energy guide chain—in a fully wound position—makes contact with the winding core with most of its length, with windings positioned on top of each other without space between the windings. This can be achieved in particular if the energy guide chain extends according to an archimedic spiral or without space between its windings. On the other hand, the energy guide chains in a fully unwound position preferably extend about the rotational axis with most of their length in a manner corresponding to a circular arc pointing away from the winding core. For example, they can form a J-shape in plan view. Thus, most of their length can be in contact with an outer shell or a cylindrical outer wall and/or slide off the same, which supports, for example, the torque transfer in this position. A cantilevered, fully extended strand extends from the circular arc to the winding core, which strand can act like a lever arm. Between the two positions, the energy guide chains can extend similarly to a helical spring, i.e., like a tight, or wound further about the rotational axis, spiral arm, or with windings that “constrict” when being wound and “rise up” when being unwound.

Preferably, a housing with a cylindrical outer wall is provided, on which outer wall most of the length of a fully unwound energy guide chain is supported.

Preferably, the preferably identical winding cores in the middle range are designed as hollow cylinders in their central section, such that the winding cores can be arranged coaxially on a shared rotary shaft. Regardless of this, the connecting points, which are rotatable to each other, can be formed by the axially outer or end areas of two respective winding cores or be firmly connected to these.

Not exclusively, but especially in the case of line guide devices extending in opposite directions, an even number of groups of identical modules comprising at least one winding core with its associated energy guide chain is preferably provided

In one embodiment, a support disc may be provided as an axial separation between two respective, axially successive energy guide chains, in particular of two cascaded modules, which support disc is connected to a winding core or winding body in a rotationally fixed manner. The support disc may, if necessary, form a connecting body for transferring force or torque. A support disc may be provided, for example, between the first and the second winding core, or on only one of two winding cores of a module with two energy guide chains.

Conventional energy guide chains also are particularly suitable for the production of the proposed rotary feed-through. However, it is also conceivable to equip the proposed rotary feed-through with line guide devices in order to achieve circular movements across a limited rotational angle of a line between two connecting points rotatable relative to each other about a rotational axis, which line guide devices are not actual link chains, but, e.g., so-called conveyor chains, which are executed in one piece at least in sections.

The inventive idea, in particular according to Claim 16, can therefore be summarized as follows. A first winding core, rotatable about the rotational axis, is equipped with a first line guide device for guiding the line, which can be wound helically onto the first winding core or can be unwound from the same.

According to the invention, at least one second winding core with a second line guide device for guiding the line is provided axially adjacent to the first winding core. Furthermore, the second winding core is coaxial and rotatable about the rotational axis relative to the first winding core, in order to wind the second line guide device helically onto the second winding core or to unwind it from the same.

All embodiments shown above can be combined with Claim 16. The invention allows for a compact system that is easy to manufacture for providing uninterrupted lines for circular movements across a limited rotational angle by means of a rotary feed-through according to any one of the aforementioned exemplary embodiments. A significant advantage is that, in the final state, the at least one line is guided continuously, i.e., without interruption, from the first connecting point to the second connecting point through the rotary feed-through.

Further advantageous features of the invention are explained in more detail below—without constraining the generality of the statements above—on the basis of several preferred exemplary embodiments with reference to the attached drawings. The drawings show:

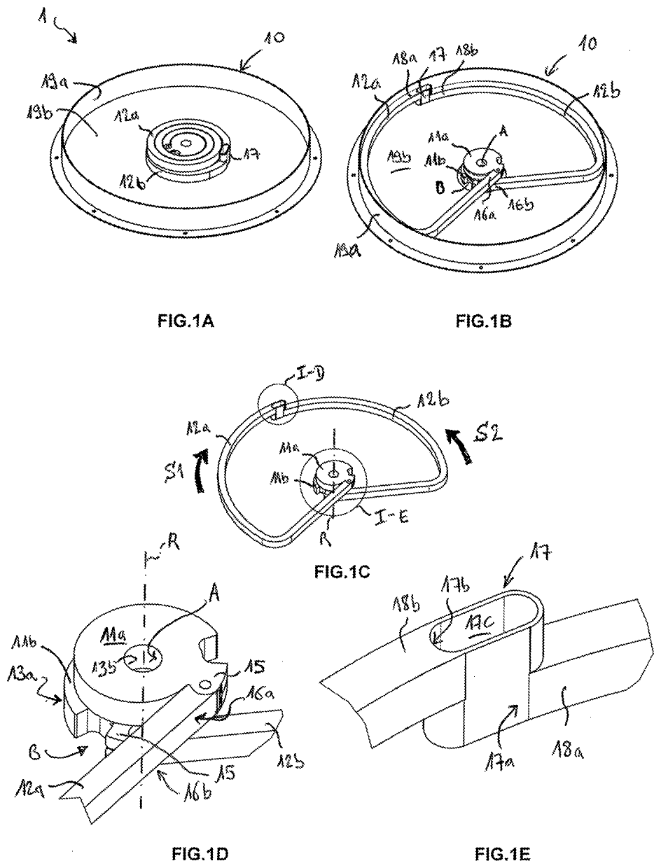

FIGS. 1A-1B: Perspective views of a module for a modular rotary feed-through according to a preferred first exemplary embodiment, in a position with two fully wound energy guide chains (FIG. 1A) and in a position with two fully unwound energy guide chains (FIG. 1B).

FIGS. 1C-1E: Perspective partial views of FIGS. 1A-1B with enlarged views in FIG. 1C of the rotatable winding cores associated with the respective energy guide chains (FIG. 1D), and a connecting link (FIG. 1E) between both energy guide chains.

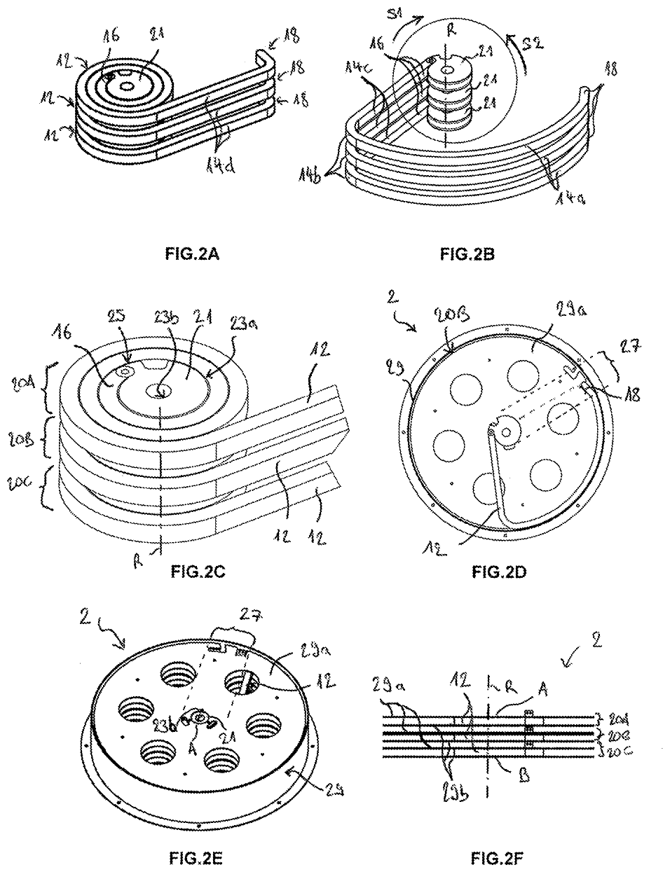

FIGS. 2A-2B: Perspective partial views of a rotary feed-through according to a second exemplary embodiment, in a position with two fully wound energy guide chains (FIG. 2A) and in a position with two fully unwound energy guide chains (FIG. 2B).

FIG. 2C: An enlarged, perspective partial view of FIG. 2B for illustrating the rotatable winding cores in a fully wound rotational position.

FIGS. 2D-2F: Further views of a rotary feed-through according to FIGS. 2A-2B with a top view of a rotary step (FIG. 2D), a perspective view (FIG. 2E) and a cross-section (FIG. 2F) of the rotary feed-through with associated housing parts.

FIGS. 1A-1E show a basic module 10 in two end positions of the rotational movement. The basic module 10 individually, or together with other identical basic modules 10 (not shown here), forms a rotary feed-through 1 for circular movements of lines across a limited rotational angle. The lines (not shown) are guided between two connecting points A, B without interruption, wherein the connecting points A, B are rotatable relative to each other about a rotational axis R, with only one basic module 10, e.g., via a rotational angle of ≥720°. Of course, more-compact modules with a smaller rotational angle are also possible.

The basic module 10 comprises a first winding body or winding core 11a, which is rotatable about the rotational axis R, with a first energy guide chain 12a, the design of which is known in principle, which is fixed on the end side at the winding core 11a (see FIG. 1D). For this purpose, an end fastening area or connection area 15 is provided at the winding core 11a, which has a joint half, which is identical to a joint half of a chain link of the energy guide chain 12a. The inner end 16a of the energy guide chain 12a facing the rotational axis R is attached in a pivotable manner to the winding core 11a by means of the connection area 15, for example by two opposite flange parts with articulated openings for articulated pins of the chain link, as FIG. 1D shows schematically.

Along the rotational axis R, axially adjacent to the first winding core 11a, the basic module 10 has a second winding core 11b, which here is designed identical to the first winding core 11a. An identical second energy guide chain 12b correspondingly is attached with its radial inner end 16b in a pivotable manner at the connection area 15 of the second winding core 11b. As FIGS. 1A-1C show, the two energy guide chains 12a, 12b extend about the rotational axis R in two axially distanced planes. Therein, the winding cores 11a, 11 b hold the inner ends 16a, 16b with axial play.

Both winding cores 11a, 11 b are arranged coaxially and rotatable relative to each other with respect to the rotational axis R, and for this purpose are supported in an appropriate manner, e.g., on a rotary shaft (not shown). When the energy guide chains 12a, 12b are rotated relative to each other about the rotational axis R between a first, fully wound rotational end position (FIG. 1A) and a second, fully unwound rotational end position (FIG. 1B), each energy guide chain 12a or 12b is wound or unwound in a plane around the associated winding core 11a or 11 b in a helical manner corresponding to a planar spiral. The energy guide chains 12a, 12b therein extend in the shape of a spiral arm with increasingly tighter or, respectively, wider distances between windings.

The wound rotational end position in FIG. 1A shows how both energy guide chains 12a, 12b make contact in a compact manner, i.e., with all helical windings without space between the windings radially adjacent to the rotational axis R, and close to the winding core 11a or 11b. As most easily visible in FIGS. 1B-1C, in the example according to FIGS. 1A-1E, the helical rotational direction or the winding direction of the first energy guide chain 12a around the first winding core 11a corresponds to a first rotational direction S1 and the winding direction of the second energy guide chain 12b around the second winding core 11b corresponds to an opposite second rotational direction S2 about the rotational axis. The winding direction of the successive energy guide chains 12a, 12b thus is opposite to that in FIGS. 1A-1E. Both energy guide chains 12a, 12b preferably have the same length (in the longitudinal direction of the chain) or the same number of identical chain links.

The first winding core 11a, starting from the end position in FIG. 1A, can execute a number of rotations, e.g., n≥2 complete rotations, about the rotational axis R in the rotational direction S1 relative to the second winding core 11b until the end position in FIG. 1B is reached. Conversely, the relative rotation takes place in the opposite rotational direction S2 from the unwound end position in FIG. 1B until the end position in FIG. 1A is again reached. Of course, it has the same effect if the second winding core 11b rotates relative to the first winding core 11a in the rotational direction S1 to the end position in FIGS. 1A and 1n the rotational direction S2 back to the end position in FIG. 1B, depending on whether and which winding core 11a, 11 b is attached in a rotationally fixed manner on a stationary part with a connecting point A, B, if applicable. Even larger rotation angles can be achieved by means of longer energy guide chains 12a, 12b, wherein the basic module 10 can retain the same dimensions, if necessary.

Both winding cores 11a, 11 b have a circumferential cylindrical contact surface 13a on their outer side for supporting the respective energy guide chain 12a or 12b in the end position according to FIG. 1A. The contact surface 13a has a radius that increases starting from the connection area 15, which radius preferably follows an archimedic spiral about the rotational axis R, as can be seen in FIG. 1D.

As most easily visible in FIG. 1D, the winding cores 11a, 11b are hollow cylinders in their center sections, with a circular cylindrical inner wall concentric to the rotational axis R designed as a central receptacle 13b for attaching to a rotary shaft (not shown), among other functions. Both winding cores 11a, 11 b can be rotatably supported by means of the receptacle 13b. The receptacle 13b has a radial opening for the line(s), while a corresponding radial opening or recess in the contact surface 13a is provided adjacent to the connection area 15 in the circumferential direction to guide the line(s) away from or toward the rotational axis R into or out of the respective energy guide chains 12a or 12b.

Furthermore, the basic module 10, as shown in FIGS. 1A-1B, here has housing parts such as an outer wall 19a for supporting a longitudinal section 14a extending in a circular arc of each energy guide chain 12a, 12b in the fully unwound end position according to FIG. 1B. Accordingly, the outer wall 19a is arranged as a circular cylinder and coaxial to the rotational axis R.

In its unwound rotational end position (FIG. 1B), each energy guide chain 12a, 12b preferably makes contact with mosts of its length in the longitudinal section 14a against the outer wall 19a in the shape of a circular arc, or is radially extended against the same. The curved longitudinal section 14a transitions with a deflection curve 14b into a fully extended section 14c, which leads to the radial inner end 16a or 16b at the winding core 11a or 11b. The fully extended section 14c may be preloaded in the main curvature direction of the deflection curve 14b. Furthermore, energy guide chains 12a, 12b are used here, whose chain links can only be pivoted to each other in one of these main directions (i.e., without a reverse bending radius). The preload and/or pivot direction can be ensured analogously to the intended minimum permissible main radius in the deflection curve 14b by suitable angular stops of the chain links.

FIGS. 1A-1B show a flat support disc 19b coaxial to the rotational axis R. The support disc 19b separates cascaded basic modules 10 axially from each other and thus supports the energy guide chains 12a, 12b in the axial direction. At the end face, which remains open, of multiple cascading basic modules 10 (FIGS. 1A-1B), an additional support disc (not shown) can be provided for closing the housing on the end face. The support disc 19b is freely rotatable about the rotational axis R relative to the second winding core 11b or arranged in a rotationally fixed manner relative to the same and rotatable to the outer wall 19a about the rotational axis R. Furthermore, the support disc 19b may have a central opening for connecting adjacent winding cores 11a, 11 b of two successive basic modules 10 in a rotationally fixed manner to each other. FIG. 1E shows how the two energy guide chains 12a, 12b of a basic module 10 are serially linked for feeding through the line(s) in the first exemplary embodiment. For this purpose, the respective radial outer ends 18a, 18b of the energy guide chains 12a, 12b are articulated to each other by means of a connecting link 17 designed as a special part. The connecting link 17 has two connecting areas 17a, 17b on both sides facing away from each other in the circumferential direction, matched to the energy guide chains 12a, 12b. The connecting areas 17a, 17b can be designed as joint halves matching a joint half of the chain links of the identical energy guide chains 12a, 12b, for example. The connecting areas 17a, 17b are arranged in offset planes axially, i.e., in the direction of the rotational axis R, and are linked with the ends 18a, 18b in a force-transferring manner. The offset is slightly larger than the width of the chain links (transverse to the longitudinal direction of the chain or along R) to achieve axial play. An inner cavity 17c in the connecting link 17 bridges this axial offset and allows for the line to be guided from one energy guide chain 12a, 12b into the serially subsequent one. The connecting link 17 thus forms a kind of chain link to the axially offset connection of the two energy guide chains 12a, 12b. Thus, a bundle of different lines can be guided continuously from the connecting point A to the connecting point B rotatable relative to the former through the one energy guide chain 12a, the connecting link 17 and the second energy guide chain 12b, and can be protected within these components, in particular against pinching.

FIGS. 2A-2F show an alternative exemplary embodiment with several axially cascaded modules 20A, 20B, 20C. Here, by way of an example, three modules 20A, 20B, 20C together form a rotary feed-through 2. Each module 20A, 20B, 20C comprises a winding core 21 and an associated energy guide chain 12, which is fixed at the connection area 25 of the winding core 11 with its inner end 16 in a pivotable manner. Each winding core 21 has an outer contact surface 23a for the energy guide chain 12 and an inner receptacle 23b for rotational support, as described above. The winding core 21 in FIGS. 2A-2F can have the same design as in the first example, and is not again described in detail.

FIGS. 2A-2B show the modules 20A, 20B, 20C only partially with the winding core 21 and energy guide chain 12, in both rotational end positions about the rotational axis R, fully wound (FIG. 2A) and fully unwound (FIG. 2B). One difference to the first example is that the energy guide chains 12 in all modules 20A, 20B, 20C extend in the same rotational direction around the associated winding core 21 (see FIG. 2A). In the fully unwound end position (FIG. 2B), all energy guide chains 12 may be spatially arranged here in the same position, each with a curved longitudinal section 14a, a deflection curve 14b and a fully extended section 14c, as in FIG. 1B. The curved longitudinal section 14a here also is supported on a cylindrical outer wall 29.

Another difference is the connection between two pairs of axially successive modules 20A-20B, 20B-20C, etc. As FIG. 2A shows, in the wound end position of FIGS. 2A-2F, respective fully extended sections 14d remain between the—preferably largest—portion of each energy guide chain 12 that is helically wound on the winding core 21 and the radial outer end 18 of the energy guide chain 12.

In FIGS. 2A-2F, a radially extended connecting body 27, e.g., in the form of a radial portion of a first support disc 29a, is provided for line guidance and rotational transfer between the outer end 18 of the energy guide chain 12 of a module 20B or 20C and the inner end of the energy guide chain 12 of a subsequent module 20A or 20B, as indicated with dotted lines in FIGS. 2D-2E. Correspondingly, each module 20A, 20B, 20C has a first support disc 29a as a third essential component besides the winding core 21 and its associated energy guide chain 12, which support disc 29a forms the connecting body 27, or an area suitable for connecting. One advantage of a plate-like support disc 29a—in contrast to a simple radial-arm—lies in the reduction of imbalance and in the axial support of the energy guide chains 12. To save weight and for the purpose of inspections, the support disc 29a can be provided with holes in a rotationally symmetrical pattern (see FIGS. 2D-2E). Optionally, a possibly identical second support disc 29b can furthermore be provided facing the first support disc 29a for the bilateral axial support of the energy guide chains 12 in each module 20A, 20B, 20C (see FIG. 2F). The second support disc 29b is not used for establishing a connection; it can be mounted on the winding body 21 in a rotationally fixed manner.

In the connection area or connecting body 27, the line(s) from the respective radially outer ends 18 of the cable carrier chain 12 of a module 20B or, respectively, 20C are guided radially inward to the rotational axis R and axially to the subsequent winding core 21 of the subsequent module 20A or 20B (indicated in FIG. 2D by a dashed line), and from there again via the radially inner end 16 of the subsequent energy guide chain 12, as seen in the direction of the line, outward to its outer end 18, etc. Accordingly, the radially outer ends 18 of the energy guide chains 12 are attached to respective connection areas 27a of the associated first support disc 29a.

Within each module 20A, 20B, 20C, the first support disc 29a, which serves as a connection 27, can be rotated coaxially to the rotational axis R and relative to the respective winding core 21. To transfer rotational movement between modules 20A, 20B, 20C, the first support disc 29a can be connected to the winding core 21 of the respective axially adjacent next module 20A, 20B, 20C in a rotationally fixed manner, such that one module drives the respective next module and the rotation is transferred in steps or in the manner of cascade. Excluded from this is the first module 20A on the front, where the first support disc 29a forms a connecting point A or is attached to the same in a rotationally fixed manner. At the other axial end, for example, the winding core 21 of the last module 20C, for example, its inner receptacle 23b, can form the other connecting point B or be attached to the same in a rotationally fixed manner.

When the fully wound rotational position according to FIG. 2A is reached, torque is transferred in the first rotational direction S1 within each module 20A, 20B, 20C by means of tensile force from the winding core 21 via the energy guide chain 12 to the first support disc 29a, which then drives the winding core 21 of the subsequent module in the rotational direction S1. Conversely, torque is transferred in the second rotational direction S2 by thrust from the winding core 21 via the energy guide chain 12 to the support disc 29a and thus to the next module. To establish a connection in a rotationally fixed manner, protrusions can be provided at the winding core 21 on the front side, which interact with corresponding recesses in the support discs 29a and, if applicable, 29b in a positive locking manner to transfer torque.

Modules 20A-20C, as shown in FIGS. 2A-2F, can also realize a rotary feed-through 2 with an odd number of energy guide chains 12 or rotational planes.

### LIST OF REFERENCE NUMBERS

### FIGS. 1A-1E

A, B Connecting points
R Rotational axis
S1, S2 Rotational direction
1 Rotary feed-through
10 Basic module
11a, 11b Winding core
12a, 12b Energy guide chain
13a Contact area
13b Inner receptacle
14a Curved longitudinal section
14b Deflection curve
14c Fully extended section
15 Connection area
16a, 16b Inner end
17 Connection link
17a, 17b Connection areas
18a, 18b Outer end
19a Outer wall (housing)
19b Support disc

### FIG. 2A-2F

A, B Connecting points
R Rotational axis
S1, S2 Rotational direction
2 Rotary feed-through
12 Energy guide chain
14a Curved longitudinal section
14b Deflection curve
14c Fully extended section
16 Inner end
18 Outer end
20A, 20B, 20C Module
21 Winding core
23a Contact area
23b Inner receptacle
25 Connection area
27 Connection body/Connection area
27a Connection area
29 Outer wall (housing)
29a Support disc
29b Support disc

1. A rotary feed-through (1; 2) for circular movements across a limited rotational angle of at least one line, which is to be guided in an uninterrupted manner between two connecting points (A, B) which are rotatable relative to one another about a rotational axis, the rotary feed-through comprising;
a first winding core (11a, 11) which is rotatable about the rotational axis (R) and which has a first energy guide chain (12a, 12), the inner end (16a, 16) of which is fixed on the winding core (11a, 11), wherein the first winding core during its rotation winds and unwinds the first energy guide chain (12a, 12) in a spiraling manner, correspondingly to a planar spiral,
at least one second winding core (11b, 11) is provided axially adjacent to the first winding core (11a, 11), which second winding core (11b, 11) has a second energy guide chain (12b, 12), the inner end (16b) of which is fixed on the winding core (11b, 11), wherein the second winding core (11b, 11) is coaxial and rotatable about the rotational axis (R) relative to the first winding core (11a, 11) and wherein the second winding core (11b, 11), during its rotation, winds and unwinds the second energy guide chain (12b, 12) in a spiraling manner, correspondingly to a planar spiral, and in that a connection (17, 27) for feeding through the at least one line is provided between the first energy guide chain (12a, 12) and the second energy guide chain (12b, 12), and in that the connecting points (A, B), which are rotatable relative to each other, are formed by axially outer portions of two respective winding cores (11a, 11b) or are firmly connected to the same.

2. The rotary feed-through according to claim 1, wherein the connection (17) between both outer ends (18a, 18b) of the first and second energy guide chain is provided, or the connection (27) between an outer end (18) of the first energy guide chain and the inner end (16) of the second energy guide chain is provided.

3. The rotary feed-through according to claim 1, wherein at least one winding core (11a, 11b, 11) has a central, axially continuous receptacle (13b, 23b) in the shape of a hollow cylinder coaxial to the rotational axis (R).

4. The rotary feed-through according to claim 1, wherein the two energy guide chains (12a, 12b) have a predefined curvature direction.

5. The rotary feed-through according to claim 2, wherein the first energy guide chain (12a) and the second energy guide chain (12b) are arranged around the associated winding core (11a, 11b) with opposite rotational directions (S1, S2), wherein the two outer ends (18a, 18b) of the first and second energy guide chains (12a, 12b) are connected by means of a connecting link (17) for feeding through the at least one line.

6. The rotary feed-through according to claim 5, wherein a rotational movement is transferable from the first winding core (11a) to the second winding core (11b) by the energy guide chains (12a, 12b).

7. The rotary feed-through according to claim 2, wherein the outer end (28a) of the first energy guide chain (22) is connected to the second winding core (21) via a radially extended connecting body (27), such that rotational movement is transferred from the first winding core (21) to the second winding core (21) by the first energy guide chain (22) and the connecting body (27).

8. The rotary feed-through according to claim 5, further comprising:
a third winding core (21) rotatable about the rotational axis (R) with a helically arranged third energy guide chain (22), and
a fourth winding core rotatable about the rotational axis with a helically arranged fourth energy guide chain are provided, and
wherein all winding cores (21) are coaxial and rotatable relative to each other.

9. The rotary feed-through according to claim 1, wherein all energy guide chains (12a, 12b, 22) include chain links pivotable relative to each other in only one pivoting direction.

10. The rotary feed-through according to claim 9, wherein the first and second winding cores (11a, 11b, 21) each include a connection area (15, 25), which has a joint half for connecting the inner end (16a, 16b) of the energy guide chain (12a, 12b, 22), said joint half being identical in design to the chain link of the energy guide chain.

11. The rotary feed-through according to claim 1, wherein each energy guide chain (12a, 12b, 22) in a fully wound position makes contact with the associated winding core (11a, 11b, 21) with most of its length, without space between the windings, and in a fully unwound position extends about the rotational axis (R) with most of its length in a manner corresponding to a circular arc pointing away from the winding core (11a, 11b).

12. The rotary feed-through according to claim 11, further comprising a housing with a cylindrical outer wall (19a) on which most of the length of a fully unwound energy guide chain (11a, 11b) is supported.

13. The rotary feed-through according to claim 5, wherein a number of identical modules (10) are provided, each with at least one winding core and associated energy guide chain.

14. The rotary feed-through according to claim 7, further comprising a support disc (19b; 29a, 29b) between axially successive energy guide chains or modules.

15. A rotary feed-through for circular movements across a limited rotational angle of a line between two connecting points (A, B) which are rotatable relative to one another about a rotational axis (R), the rotary feed-through comprising:
a first winding core (11a) which is rotatable about the rotational axis (R) and which has a first line guide device (12a) for guiding the line, which can be wound helically onto the first winding core (11a) or can be unwound from the same,
at least one second winding core (11b) axially adjacent to the first winding core (11a), the at least one second winding core (11b) includes a second line guide device (12b) is provided for guiding the line,
wherein the second winding core (11b) is coaxial and rotatable relative to the first winding core (11a) about the rotational axis (R) to wind the second line guide device helically onto the second winding core (11b) or to unwind it from the same,
wherein a connection (17, 27) is between the first line guide device (12a, 12) and the second line guide device (12b, 12) for guiding the at least one line, and in that the connecting points (A, B), which are rotatable relative to each other, are formed by axially outer portions of two respective winding cores (11a, 11b) or are firmly connected to the same.

16. A system for providing uninterrupted lines for circular movements across a limited rotational angle, the system comprising a rotary feed-through according to claim 15 and at least one line, which is guided without interruption from the first connecting point (A) to the second connecting point (B) through the rotary feed-through.

17. A system for providing uninterrupted lines for circular movements across a limited rotational angle, the system comprising a rotary feed-through according to claim 1 and at least one line, which is guided without interruption from the first connecting point (A) to the second connecting point (B) through the rotary feed-through.

18. The rotary feed-through according to claim 1, wherein at least one winding core (11a, 11b, 11) has a central, axially continuous receptacle (13b, 23b) in the shape of a hollow cylinder coaxial to the rotational axis (R), wherein both winding cores (11a, 11b) are designed identically.

19. The rotary feed-through according to claim 1, wherein the first energy guide chain (12a) and the second energy guide chain (12b) are arranged around the associated winding core (11a, 11b) with opposite rotational directions (S1, S2).
